(19) United States
(12) Patent Application Publication
(10) Pub. No.: US 2014/0358744 A1
(43) Pub. Date: Dec. 4, 2014

(54) BITEMPORAL MILESTONING OF MODEL FREE DATA

(71) Applicant: Bank of America Corporation, Charlotte, NC (US)

(72) Inventors: Rituraj Deb Nath, Stamford, CT (US); Nick Lai, Stamford, CT (US); Michael P. Hickin, New York, NY (US); Sunanda Bera, Stamford, CT (US); Edwin S. Choi, New York, NY (US); Terence R. Smith, Madison, NJ (US)

(21) Appl. No.: 13/912,469

(22) Filed: Jun. 7, 2013

Related U.S. Application Data
(60) Provisional application No. 61/829,345, filed on May 31, 2013.

(51) Int. Cl. G06Q 40/00

(52) U.S. Cl. CPC G06Q 40/12
USPC 705/30

(57) ABSTRACT

Embodiments of the invention are directed to systems, methods and computer program products for bitemporal milestoning. An exemplary apparatus is configured to: receive a fact; store the fact in a database, wherein the storing of the fact is associated with a first system starting time, a first system ending time, a first business starting time, and a first business ending time; create a second version of the fact at a second system starting time, wherein the second version of the fact is associated with a second business starting time and a second business ending time; and query the database to obtain information associated with the fact at a specified business time and a specified system time, wherein the fact is stored and queried without modeling the fact based on a database schema.

### CROSS-REFERENCE TO RELATED APPLICATIONS

This application claims priority to U.S. Provisional Patent Application Ser. No. 61/829,345, filed May 31, 2013, entitled “Bitemporal Milestoning of Model Free Data,” the entirety which is incorporated herein by reference.

### BACKGROUND

There is a need for recapture of information “as it actually was” along with “as it was recorded” at a moment in time.

### BRIEF SUMMARY

In some embodiments, an apparatus is provided for bitemporal milestoning. The apparatus comprises a memory; a processor; and a module stored in the memory, executable by the processor, and configured to: receive a fact; store the fact in a database, wherein the storing of the fact is associated with a first system starting time, a first system ending time, a first business starting time, and a first business ending time; create a second version of the fact at a second system starting time, wherein the second version of the fact is associated with a second business starting time and a second business ending time; and query the database to obtain information associated with the fact at a specified business time and a specified system time, wherein the fact is stored and queried without modeling the fact based on a database schema.

In some embodiments, the database comprises a relational database.

In some embodiments, the database comprises a Resource Description Framework (RDF) store.

In some embodiments, the fact comprises information associated with an account.

In some embodiments, the specified business time and the specified system time are specified by a user.

In some embodiments, the database schema comprises a blueprint for constructing the database.

In some embodiments, the fact is stored as part of a collection of related facts.

In some embodiments, the first business starting time and the first business ending time comprise a business time period, and wherein the first system starting time and the first system ending time comprise a system time period.

In some embodiments, the second business starting time is after the first business starting time and the second business ending time is after the first business ending time.

In some embodiments, the second business starting time is before the first business starting time and the second business ending time is before the first business ending time.

In some embodiments, the second business starting time is before the first business starting time and the second business ending time is after the first business ending time.

In some embodiments, the second business starting time is after the first business starting time and the second business ending time is before the first business ending time.

In some embodiments, the fact is plotted on a dual-axis map, wherein a first axis of the map comprises a system time axis, and wherein a second axis of the map comprises a business time axis.

In some embodiments, the stored fact was valid at the first system starting time, and the second version of the fact is created because the stored fact was determined to not be valid at the second system starting time.

In some embodiments, the second version of the fact is different from the fact and is not valid at the first system starting time.

In some embodiments, the query is submitted via a user interface.

In some embodiments, a method is provided for bitemporal milestoning. The method comprises: receiving a fact; storing the fact in a database, wherein the storing of the fact is associated with a first system starting time, a first system ending time, a first business starting time, and a first business ending time; creating a second version of the fact at a second system starting time, wherein the second version of the fact is associated with a second business starting time and a second business ending time; and querying the database to obtain information associated with the fact at a specified business time and a specified system time, wherein the fact is stored and queried without modeling the fact based on a database schema.

In some embodiments, a computer program product is provided for bitemporal milestoning. The computer program product comprises a non-transitory computer-readable medium comprising a set of codes for causing a computer to: receive a fact; store the fact in a database, wherein the storing of the fact is associated with a first system starting time, a first system ending time, a first business starting time, and a first business ending time; create a second version of the fact at a second system starting time, wherein the second version of the fact is associated with a second business starting time and a second business ending time; and query the database to obtain information associated with the fact at a specified business time and a specified system time, wherein the fact is stored and queried without modeling the fact based on a database schema.

### BRIEF DESCRIPTION OF THE DRAWINGS

Having thus described embodiments of the invention in general terms, reference will now be made to the accompanying drawings, where:

FIG. 1 is an exemplary dual-axis map for bitemporal milestoning, in accordance with embodiments of the present invention;

FIG. 2 is a block diagram illustrating technical components of a system for implementing the various processes described herein, in accordance with embodiments of the present invention;

FIG. 3 is an exemplary process flow for bitemporal milestoning, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for bitemporal milestoning. The present invention enables grouping of facts into logical collections, and asserting the facts without a model. By removing the need for a model to assert the facts, the present invention enables more accurate assertion of the facts because models, by definition, are not accurate enough.

Bitemporal milestoning enables recapture of information “as it actually was” along with “as it was recorded” at a past moment in time. Specifically, bitemporal milestoning enables representation of facts, querying of facts, and reconstruction of facts at any historical moment in time and without the existence of a model. As used herein, a model may comprise a database schema that comprises a blueprint for constructing a database. The processes of representing facts, querying facts, and reconstructing facts may comprise the assertion of facts as described herein.

A temporal database is a database that handles data (e.g., facts) involving time periods, where each time period includes a starting time and an ending time. In embodiments where a temporal database is associated with a financial institution, a fact may be associated with an account (e.g., a balance of an account). A fact recorded in a bitemporal database is associated with both a system time period and a business time period. A system time period is the period during which a fact stored in the database is considered to be true. A business time (“biz time”) period is the period during which a fact is considered to be true with respect to the real world.

As indicated previously, each time period includes a starting time and an ending time. The system time period is associated with a starting system time and an ending system time. The starting system time includes a timestamp value (e.g., date and time) when a fact was recorded in a database. The ending system time includes a timestamp value when a fact was updated or deleted from the database. The business time period is also associated with a starting business time and an ending business time. The starting business time includes a timestamp value when a fact starts being valid in the real world. The ending business time includes a timestamp value when a fact stops being valid in the real world.

When new facts are received into the database, they may result in multiple temporal facts being created based on the business and system start times as described herein. Old facts are not mutated and a single published fact may result in multiple stored temporal facts as described herein.

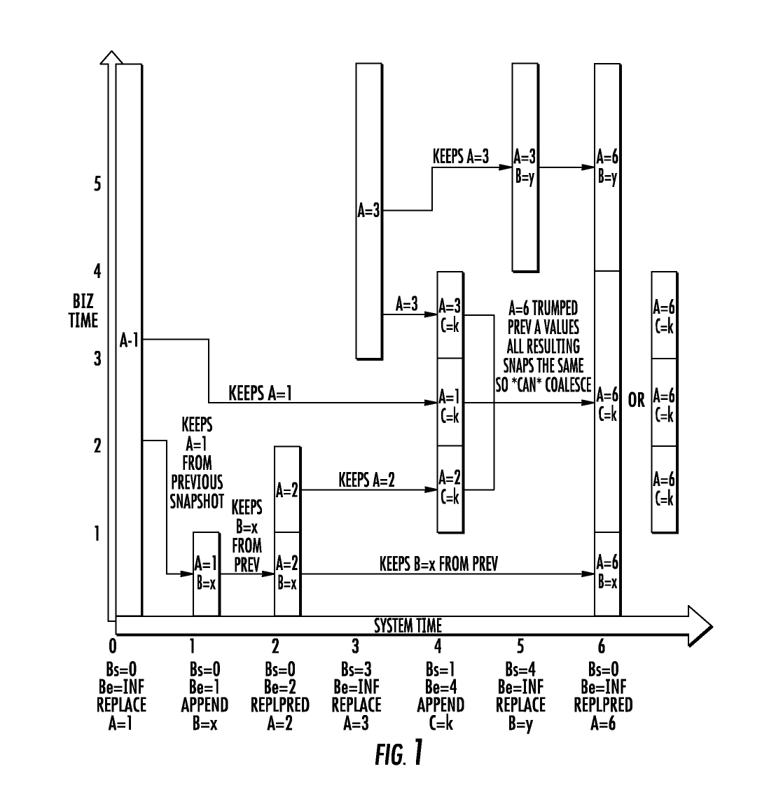

Referring now to FIG. 1, FIG. 1 presents facts that are asserted on a dual axis map. The y-axis represents business time and the x-axis represents system time. “Bs” stands for business start time and “Be” stands for business end time. “ST” stands for system time (or system start time). “A” and “B” represents facts that may be assigned values (e.g., 1, 2, 3, x, k, y, or the like). At ST=0, A=1 for the business time period from Bs=0 to Be=infinity. At ST=1, for the business time period from Bs=0 to Be=1, B=x is appended to A=1. At ST=2, for the business time period from Bs=0 to Be=2, the value of A is changed to 2 (i.e., A=2). At ST=3, for the business time period from Bs=3 to Be=infinity, the value of A is changed to 3 (i.e., A=3). At ST=4, for the business time period from Bs=1 to Be=4, C=k is appended. At ST=5, for the business time period from Bs=4 to Be=infinity, the value of B is set to y (i.e., B=y). At ST=6, for the business time period from Bs=0 to Be=infinity, the value of A is changed to 6 (i.e., A=6). Note that the facts, which may or may not be related to each other, may or may not change independently of each other.

TABLE 1
Exemplary Fact Scenario

| | Business | Business | System | System | |
|---|---|---|---|---|---|
| Serial | Starting | Ending | Starting | Ending | |
| No. | Time | Time | Time | Time | Fact |
| 1 | T0 | 9999 | T0 | 9999 | Receiving information associated with |
| | | | | | an account |
| 2 | T0 | 9999 | T0 | 9999 | Receiving information associated with |
| | | | | | a first party |
| 3 | T0 | 9999 | T0 | 9999 | Receiving information associated with |
| | | | | | a second party |
| 4 | T0 | 9999 | T0 | 9999 | Receiving information associated with |
| | | | | | a third party |
| 5 | T0 | 9999 | T0 | 9999 | Receiving information associated with |
| | | | | | a fourth party |
| 6 | T0 | T1 | T0 | T1 | Linking the account to the first party |
| 7 | T0 | T1 | T1 | T2 | Linking the account to the second |
| | | | | | party |
| 8 | T2 | 9999 | T2 | 9999 | Linking the account to the third party |
| 9 | T0 | T1 | T3 | 9999 | Linking the account to the fourth party |

Referring now to Table 1, Table 1 presents a set of facts along with how the facts change through various business time (BT) periods and system time (ST) periods. As indicated by Table 1, at ST0, the account was linked to the first party. At ST1, upon realizing that the account was incorrectly linked to the first party, the account was linked to the second party as of BT0. At ST2, the account was transferred, as of BT3, to the third party. At ST3, after realizing that the correction for BT0-BT1 was incorrect, the account is linked to the fourth party for BT0-BT1.

As indicated by Table 1, the only fact about the account that is in effect at BT1.5 is Fact No. 1. Fact Nos. 6, 7, and 9 have business end times of BT1 and are not in effect at BT1.5, while Fact No. 8 does not go into effect until BT2.

As indicated previously, a user may construct and submit queries to find out the status of the account at a particular business time and/or system time. An exemplary query is a query that asks which party is linked to the account at the current business time. In order to process this query, the system selects the most recent (system time) snapshot that includes the current business time. The answer to this exemplary query is the third party.

Another exemplary query is a query that asks which party is linked to the account at BT0.5. In order to process this query, the system selects the most recent (system time) snapshot that includes BT0.5. The answer to this exemplary query is the fourth party.

Another exemplary query is a query that asks which party is linked to the account at BT0.5 at ST1.5. In order to process this query, the system selects the ST1.5 snapshot that includes BT0.5. The answer to this exemplary query is the second party.

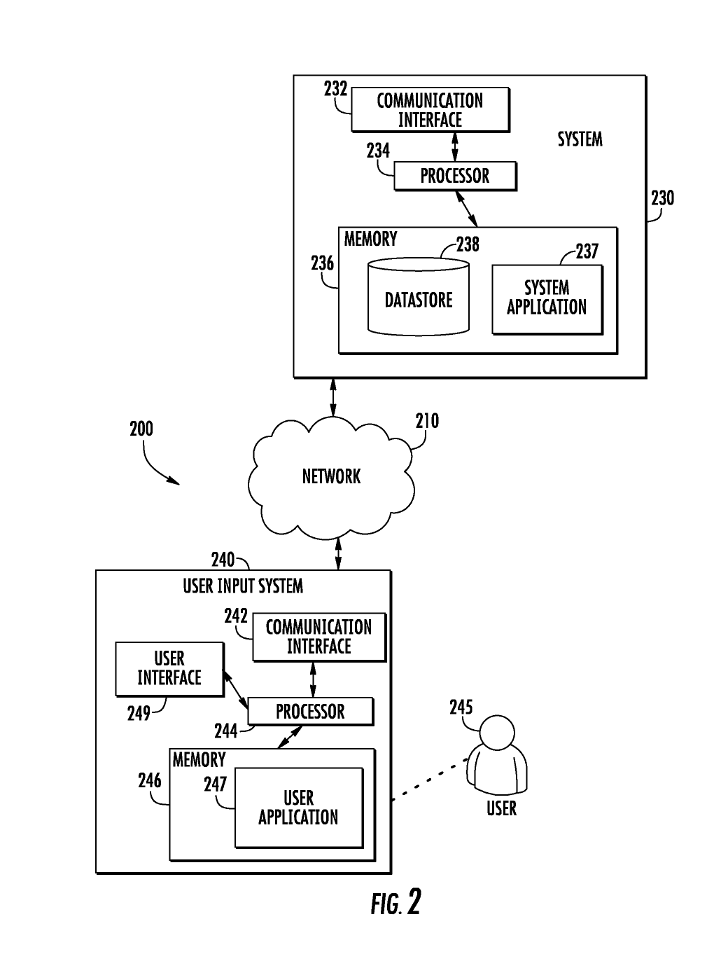

Referring now to FIG. 2, FIG. 2 presents an exemplary block diagram of the system environment 200 for implementing any of the process flows described herein, in accordance with embodiments of the present invention. As illustrated, the system environment 200 includes a network 210, a system 230, and a user input system 240. Also shown in FIG. 2 is a user 245 of the user input system 240. The user input system 240 may be a mobile device (e.g., a portable mobile communication device). The user 245 may be a person who uses the user input system 240 to execute a user application 247 (e.g., a fact-storing, a fact-creating, or fact-querying application). The system 230 may be the apparatus described herein that hosts or manages the database comprising the facts described herein. The user application 247 and/or the system application 237 may incorporate one or more parts of the process flow 300 or any other function described herein. The user 245 may use the user input system 240 to perform one or functions as described herein.

As shown in FIG. 2, the system 230, and the user input system 240 are each operatively and selectively connected to the network 210, which may include one or more separate networks. In addition, the network 210 may include a local area network (LAN), a wide area network (WAN), and/or a global area network (GAN), such as the Internet. The network may also include a mobile telecommunication network. It will also be understood that the network 210 may be secure and/or unsecure and may also include wireless and/or wireline and/or optical interconnection technology.

The user input system 240 may include any computerized apparatus that can be configured to perform any one or more of the functions of the user input system 240 described and/or contemplated herein. For example, the user 245 may use the user input system 240 to transmit and/or receive information or commands to and from the system 230. In some embodiments, for example, the user input system 240 may include a personal computer system, a mobile computing device, a personal digital assistant, a mobile phone, a network device, and/or the like. As illustrated in FIG. 2, in accordance with some embodiments of the present invention, the user input system 240 includes a communication interface 242, a processor 244, a memory 246 having an user application 247 stored therein, and a user interface 249. In such embodiments, the communication interface 242 is operatively and selectively connected to the processor 244, which is operatively and selectively connected to the user interface 249 and the memory 246. In some embodiments, the user 245 may use the user application 247 to execute processes described with respect to the process flows described herein.

Each communication interface described herein, including the communication interface 242, generally includes hardware, and, in some instances, software, that enables the user input system 240, to transport, send, receive, and/or otherwise communicate information to and/or from the communication interface of one or more other systems on the network 210. For example, the communication interface 242 of the user input system 240 may include a wireless transceiver, modem, server, electrical connection, and/or other electronic device that operatively connects the user input system 240 to another system such as the system 230. The wireless transceiver may include a radio circuit to enable wireless transmission and reception of information.

Each processor described herein, including the processor 244, generally includes circuitry for implementing the audio, visual, and/or logic functions of the user input system 240. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 247 of the memory 246 of the user input system 240.

Each memory device described herein, including the memory 246 for storing the user application 247 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 2, the memory 246 includes the user application 247. In some embodiments, the user application 247 includes an interface for communicating with, navigating, controlling, configuring, and/or using the user input system 240. In some embodiments, the user application 247 includes computer-executable program code portions for instructing the processor 244 to perform one or more of the functions of the user application 247 described and/or contemplated herein. In some embodiments, the user application 247 may include and/or use one or more network and/or system communication protocols.

Also shown in FIG. 2 is the user interface 249. In some embodiments, the user interface 249 includes one or more output devices, such as a display and/or speaker, for presenting information to the user 245. In some embodiments, the user interface 249 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 245. In some embodiments, the user interface 249 includes the input and display devices of a mobile device, which are operable to receive and display information.

FIG. 2 also illustrates a system 230, in accordance with an embodiment of the present invention. The system 230 may include any computerized apparatus that can be configured to perform any one or more of the functions of the system 230 described and/or contemplated herein. In accordance with some embodiments, for example, the system 230 may include a computer network, an engine, a platform, a server, a database system, a front end system, a back end system, a personal computer system, and/or the like. Therefore, the system 230 may be a server, apparatus, or other computing device as described herein. In some embodiments, such as the one illustrated in FIG. 2, the system 230 includes a communication interface 232, a processor 234, and a memory 236, which includes a system application 237 and a datastore 238 stored therein. As shown, the communication interface 232 is operatively and selectively connected to the processor 234, which is operatively and selectively connected to the memory 236.

It will be understood that the system application 237 may be configured to implement any one or more portions of the various user interfaces and/or process flow described herein. The system application 237 may interact with the user application 247. It will also be understood that, in some embodiments, the memory includes other applications. It will also be understood that, in some embodiments, the system application 237 is configured to communicate with the datastore 238, the user input system 240, or the like.

It will be further understood that, in some embodiments, the system application 237 includes computer-executable program code portions for instructing the processor 234 to perform any one or more of the functions of the system application 237 described and/or contemplated herein. In some embodiments, the system application 237 may include and/or use one or more network and/or system communication protocols.

In addition to the system application 237, the memory 236 also includes the datastore 238. As used herein, the datastore 238 may be one or more distinct and/or remote datastores. In some embodiments, the datastore 238 is not located within the system and is instead located remotely from the system. In some embodiments, the datastore 238 stores information or data described herein.

It will be understood that the datastore 238 may include any one or more storage devices, including, but not limited to, datastores, databases, and/or any of the other storage devices typically associated with a computer system. It will also be understood that the datastore 238 may store information in any known way, such as, for example, by using one or more computer codes and/or languages, alphanumeric character strings, data sets, figures, tables, charts, links, documents, and/or the like. Further, in some embodiments, the datastore 238 may include information associated with one or more applications, such as, for example, the system application 237. It will also be understood that, in some embodiments, the datastore 238 provides a substantially real-time representation of the information stored therein, so that, for example, when the processor 234 accesses the datastore 238, the information stored therein is current or substantially current.

It will be understood that the embodiment of the system environment illustrated in FIG. 2 is exemplary and that other embodiments may vary. As another example, in some embodiments, the system 230 includes more, less, or different components. As another example, in some embodiments, some or all of the portions of the system environment 200 may be combined into a single portion. Likewise, in some embodiments, some or all of the portions of the system 230 may be separated into two or more distinct portions.

In addition, the various portions of the system environment 200 may be maintained for and/or by the same or separate parties. It will also be understood that the system 230 may include and/or implement any embodiment of the present invention described and/or contemplated herein. For example, in some embodiments, the system 230 is configured to implement any one or more of the embodiments of any process flow described herein. Additionally, the system 230 is configured to initiate presentation of any of the user interfaces described herein.

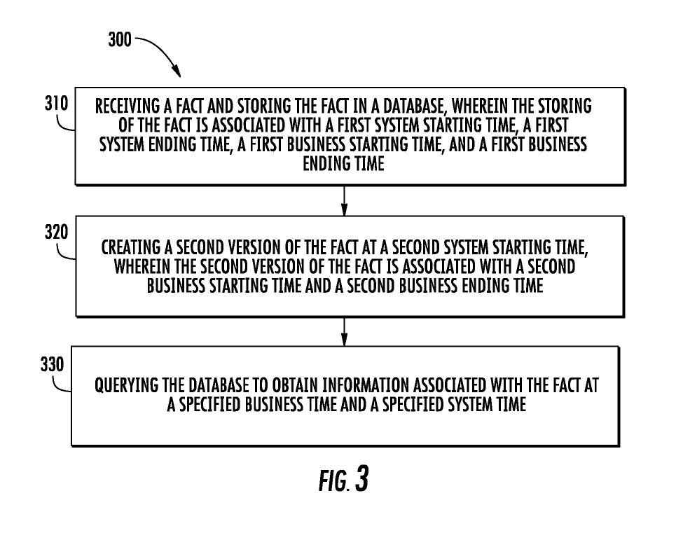

Referring now to FIG. 3, a general process flow 300 is provided for bitemporal milestoning. At block 310, the method comprises receiving a fact and storing the fact in a database, wherein the storing of the fact is associated with a first system starting time, a first system ending time, a first business starting time, and a first business ending time. At block 320, the method comprises creating a second version of the fact at a second system starting time, wherein the second version of the fact is associated with a second business starting time and a second business ending time. At block 330, the method comprises querying the database to obtain information associated with the fact at a specified business time and a specified system time. As described previously, the fact is stored and queried without modeling the fact based on a database schema.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for bitemporal milestoning, the apparatus comprising:
a memory;
a processor; and
a module stored in the memory, executable by the processor, and configured to:
receive a fact;
store the fact in a database, wherein the storing of the fact is associated with a first system starting time, a first system ending time, a first business starting time, and a first business ending time;
create a second version of the fact at a second system starting time, wherein the second version of the fact is associated with a second business starting time and a second business ending time; and
query the database to obtain information associated with the fact at a specified business time and a specified system time,
wherein the fact is stored and queried without modeling the fact based on a database schema.

2. The apparatus of claim 1, wherein the database comprises a relational database.

3. The apparatus of claim 1, wherein creation of the second version of the fact does not change the stored fact.

4. The apparatus of claim 1, wherein the database comprises a Resource Description Framework (RDF) store

5. The apparatus of claim 1, wherein the fact comprises information associated with an account.

6. The apparatus of claim 1, wherein the specified business time and the specified system time are specified by a user.

7. The apparatus of claim 1, wherein the database schema comprises a blueprint for constructing the database.

8. The apparatus of claim 1, wherein the fact is stored as part of a collection of related facts.

9. The apparatus of claim 8, wherein the collection of related facts comprises different versions of the fact.

10. The apparatus of claim 1, wherein the first business starting time and the first business ending time comprise a business time period, and wherein the first system starting time and the first system ending time comprise a system time period.

11. The apparatus of claim 1, wherein the second business starting time is after the first business starting time and the second business ending time is after the first business ending time.

12. The apparatus of claim 1, wherein the second business starting time is before the first business starting time and the second business ending time is before the first business ending time.

13. The apparatus of claim 1, wherein the second business starting time is before the first business starting time and the second business ending time is after the first business ending time.

14. The apparatus of claim 1, wherein the second business starting time is after the first business starting time and the second business ending time is before the first business ending time.

15. The apparatus of claim 1, wherein the fact and the second version of the fact are plotted on a dual-axis map, wherein a first axis of the map comprises a system time axis, and wherein a second axis of the map comprises a business time axis.

16. The apparatus of claim 1, wherein the stored fact was valid at the first system starting time, and wherein the second version of the fact is created because the stored fact was determined to not be valid at the second system starting time.

17. The apparatus of claim 1, wherein the second version of the fact is different from the fact and not valid at the first system starting time.

18. The apparatus of claim 1, wherein the query is submitted via a user interface.

19. A method for bitemporal milestoning, the method comprising:
receiving a fact;
storing the fact in a database, wherein the storing of the fact is associated with a first system starting time, a first system ending time, a first business starting time, and a first business ending time;
creating a second version of the fact at a second system starting time, wherein the second version of the fact is associated with a second business starting time and a second business ending time; and
querying the database to obtain information associated with the fact at a specified business time and a specified system time,
wherein the fact is stored and queried without modeling the fact based on a database schema.

20. A computer program product for bitemporal milestoning, the computer program product comprising:
a non-transitory computer-readable medium comprising a set of codes for causing a computer to:
receive a fact;
store the fact in a database, wherein the storing of the fact is associated with a first system starting time, a first system ending time, a first business starting time, and a first business ending time;
create a second version of the fact at a second system starting time, wherein the second version of the fact is associated with a second business starting time and a second business ending time; and
query the database to obtain information associated with the fact at a specified business time and a specified system time,
wherein the fact is stored and queried without modeling the fact based on a database schema.
